(19) United States
(12) Patent Application Publication
(10) Pub. No.: US 2012/0057651 A1
(43) Pub. Date: Mar. 8, 2012

(54) TRANSMISSION APPARATUS AND METHOD

(75) Inventor: Dong Kyoo KIM, Yeongi-gun (KR)

(73) Assignee: Electronics and Telecommunications Research Institute, Daejeon (KR)

(21) Appl. No.: 13/228,060

(22) Filed: Sep. 8, 2011

(30) Foreign Application Priority Data
Sep. 8, 2010 (KR) 10-2010-0088114
Jun. 14, 2011 (KR) 10-2011-0057663

(51) Int. Cl. H04L 25/03

(52) U.S. Cl. 375/296

(57) ABSTRACT

A transmission apparatus selects a single transmission channel through which a transmission signal is to be transmitted from among unoccupied available channels, forms the transmission signal so as to alleviate interference with adjacent channels according to occupancy states of an upper adjacent channel and a lower adjacent channel adjacent to the transmission channel, and transmits the transmission signal.

### CROSS-REFERENCE TO RELATED APPLICATION

This application claims priority to and the benefit of Korean Patent Application No. 10-2010-0088114 and 10-2011-0057663 filed in the Korean Intellectual Property Office on Sep. 8, 2010 and Jun. 14, 2011, the entire contents of which are incorporated herein by reference.

### BACKGROUND OF THE INVENTION

(a) Field of the Invention

The present invention relates to a transmission method and apparatus. More particularly, the present invention relates to a method for reducing interference between frequency channels.

(b) Description of the Related Art

In the case of communication using two or more frequency channels, interference between frequency channels, particularly, interference between adjacent channels, is a physical cause of deterioration in communication performance. A channel power spectrum mask is defined in communication standards. Thus, the upper limit of interference affecting neighboring channels at the time signal transmission has been clearly stated. However, in general, the upper limit defined by the communication standards is insufficient to solve an interference phenomenon between adjacent channels. Thus, in a case where adjacent channels or in some cases, proximity channels, are simultaneously used, an interference signal of a channel in use severely deteriorates the communication performance of the other party's channel. Actually, this occurs frequently.

Interference between channels not only deteriorates communication performance but also lowers channel efficiency. For this reason, various methods have been proposed in order to address the interference issue between channels.

The methods for solving the interference issue between channels may be classified into methods applied to a transmitter and methods applied to a receiver.

As for the methods applied to a transmitter, there has been chiefly used a method in which a transmitter monitors peripheral-channel interference power generated from the transmitter itself and controls the peripheral-channel interference power accordingly so as not to violate the upper limit on the influence of interference, defined by the corresponding wireless communication standard.

As for the methods applied to a receiver, there has been chiefly used a method for improving signal quality when a signal received from a reception channel is deteriorated in quality due to the interference of a peripheral channel.

The method for improving signal quality in a receiver will now be described. First, an autocorrelation value of a signal having passed through upper and lower adjacent channels with respect to a channel of interest is calculated, the presence of the adjacent channel interference from the upper/lower channel is checked by using the pattern characteristics of the autocorrelation value, and the degree thereof is reckoned. Secondly, the degree of the adjacent channel interference is detected, and the result of the detection is made to interwork with the sampling rate and the bits of an A/D converter, thus reducing the power consumption of the A/D converter. Thirdly, in an orthogonal frequency division multiplexing (OFDM)-based wireless communication scheme, a reception signal the quality of which has been deteriorated by the adjacent channel interference is subjected to frequency offset adjustment, thus reducing the degree of quality deterioration.

The commercial availability of a communication scheme using a multi-frequency channel from wireless communication techniques which are in widespread use, such as Wireless backhaul, wireless LAN, Worldwide Interoperability for Microwave Access (WiMAX), Long Term Evolution (LTE), and the like, to wire communication techniques such as Asymmetric Digital Subscriber Line (ADSL), Very high data rate DSL (VDSL), xDSL, digital cable communication, and the like has been increased. This worsens the interference generated between channels. Accordingly, there is an acute need for effective methods for interference between channels.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a transmission apparatus and method having advantages of reducing interference between channels

An exemplary embodiment of the present invention provides a transmission apparatus. The transmission apparatus includes an available channel search unit, a channel state recognizing unit, a transmission waveform determining unit, and a transmission processing unit. The available channel search unit determines, as a transmission channel, an available channel upper and lower adjacent channels of which are all unoccupied among one or more available channels which are not occupied by adjacent channels. The channel state recognizing unit determines, as a transmission channel, one of the one or more available channels from occupancy states of the upper adjacent channel and the lower adjacent channel when both the upper adjacent channel and the lower adjacent channel are not unoccupied; The transmission waveform determining unit allocates transmission data to at least a portion of subcarriers among entire subcarriers of the transmission channel according to the occupancy states of an upper adjacent channel and a lower adjacent channel of the transmission channel and generating, and converts the data to a baseband signal using the subcarriers allocated the transmission data. The transmission processing unit processes the baseband signal into a radio frequency signal and transmitting the radio frequency signal.

The transmission channel may include a plurality of subcarriers in an upper subcarrier region, a plurality of subcarriers in a lower subcarrier region, and a plurality of subcarriers in an intermediate subcarrier region between the upper subcarrier region and the lower subcarrier region

In this case, when only one of the upper and lower adjacent channels is unoccupied, the transmission waveform determining unit may allocate transmission data to the plurality of subcarriers of the intermediate subcarrier region of the transmission channel, and allocate the transmission data to a plurality of subcarrier in a region corresponding to the unoccupied channel.

The transmission apparatus may further include a filter unit filtering the baseband signal according to a cut-off frequency of the baseband signal and outputting the filtered baseband signal to the transmission processing unit.

The transmission waveform determining unit may determine the cut-off frequency of the baseband signal according to the occupancy states of the upper adjacent channel and the lower adjacent channel of the transmission channel.

The filter unit may include a plurality of low pass filters each filtering a signal input at each cut-off frequency and outputting the filtered signal; and an input selection unit outputting the baseband signal to one of the plurality of low pass filters according to the cut-off frequency determined from the transmission waveform determining unit.

The transmission waveform determining unit may allocate the transmission data to the entire subcarriers of the transmission channel when both the upper adjacent channel and the lower adjacent channel of the transmission channel are unoccupied.

When both the upper adjacent channel and the lower adjacent channel of the transmission channel are occupied, the transmission waveform determining unit may allocate transmission data to the plurality of subcarriers of the intermediate subcarrier region of the transmission channel, and allocate the transmission data to a portion of the subcarriers of the upper subcarrier region and a portion of the subcarriers of the lower subcarrier region.

The channel state recognizing unit may select, as a transmission channel, an available channel one of the upper and lower adjacent channels of which is occupied.

Another exemplary embodiment of the present invention provides a transmission method for a transmission apparatus. The transmission method includes selecting a transmission channel from among unoccupied available channels; mapping data to at least a portion of subcarrier of the transmission channel according to occupancy states of an upper adjacent channel and a lower adjacent channel adjacent to the transmission channel; generating a baseband signal from the subcarrier to which the data is mapped; and processing the baseband signal and transmitting the signal.

The generating may include: determining a cut-off frequency of the baseband signal according to the occupancy states of the upper adjacent channel and the lower adjacent channel adjacent to the transmission channel; and filtering the baseband signal at the cut-off frequency.

The determining may include determining the cut-off frequency according to a channel bandwidth of a subcarrier to which the data is mapped.

The generating may include allocating the data to entire subcarriers of the transmission channel when both the upper adjacent channel and the lower adjacent channel of the transmission channel are unoccupied.

Yet another embodiment of the present invention provides a transmission method for a transmission apparatus. The transmission method includes: selecting a transmission channel through which a transmission signal is to be transmitted from among unoccupied available channels; and forming the transmission signal according to occupancy states of an upper adjacent channel and a lower adjacent channel adjacent to the transmission channel.

The forming may include: selecting a subcarrier to which transmission data is to be mapped from among a plurality of subcarriers of the transmission channel according to the occupancy states of the upper adjacent channel and the lower adjacent channel; and mapping the transmission data to the selected subcarrier and converting the data into a baseband signal.

The forming may further include: determining a cut-off frequency according to a channel bandwidth of the selected subcarrier; and filtering the baseband signal at the cut-off frequency.

### BRIEF DESCRIPTION OF THE DRAWINGS

FIG. 1 is a view illustrating one example of a frequency channel used in a wireless communication system according to an exemplary embodiment of the present invention.

FIG. 2 is a view illustrating one example of a wireless communication system according to an exemplary embodiment of the present invention.

FIG. 3 is a view illustrating one example of the activation order and occupancy period of a frequency channel, being used in a wireless communication system according to an exemplary embodiment of the present invention, on a time axis.

FIG. 4 is a view illustrating interference between adjacent channels, which may occur in a wireless communication system according to an exemplary embodiment of the present invention, on a frequency axis.

FIG. 5 is a view illustrating a transmission apparatus according to an exemplary embodiment of the present invention.

FIG. 6 is a flowchart illustrating a transmission method for reducing interference between adjacent channels in a transmission apparatus according to an exemplary embodiment of the present invention.

FIG. 7 is a flowchart illustrating an available-channel search method performed in an available-channel search unit.

FIG. 8 is a flowchart illustrating a transmission-channel selection method performed in a channel state recognizing unit.

FIG. 9 is a flowchart illustrating one example of a method of selecting a transmission channel in a channel-state recognizing unit according to an exemplary embodiment of the present invention.

FIG. 10 is a flowchart illustrating a method of generating a baseband signal in a transmission waveform determining unit shown in FIG. 5.

FIG. 11 is a flowchart illustrating a subcarrier mapping method of a transmission waveform determining unit according to an exemplary embodiment of the present invention.

FIG. 12 is a block diagram illustrating one example of a filter unit according to an exemplary embodiment of the present invention.

FIG. 13 is a view illustrating interference between adjacent channels on a frequency axis according to the transmission method according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

in the specification and claims, unless explicitly described to the contrary, the word “comprise” and variations such as “comprises” or “comprising”, will be understood to imply the inclusion of stated elements but not the exclusion of any other elements.

In this specification, a terminal may refer to a mobile station (MS), a mobile terminal (MT), a subscriber station (SS), a portable subscriber station (PSS), user equipment (UE), or an access terminal (AT), and may have the entirety or portion of functions of the terminal, the mobile terminal, the subscriber station, the portable subscriber station, the user equipment, or the access terminal.

In this specification, a base station (BS) may refer an access point (AP), a wireless access station (RAS), a nodeB, an evolved node (eNodeB), a base transceiver station (BTS), or a mobile multihop relay (MMR)-BS, and may have the entirety or portion of functions of the access point (AP), the wireless access station (RAS), the nodeB, the evolved node (eNodeB), the base transceiver station (BTS), or the mobile multihop relay (MMR)-BS.

Hereinafter, a transmission method and apparatus according to an exemplary embodiment of the present invention will be described with reference to the accompanying drawings.

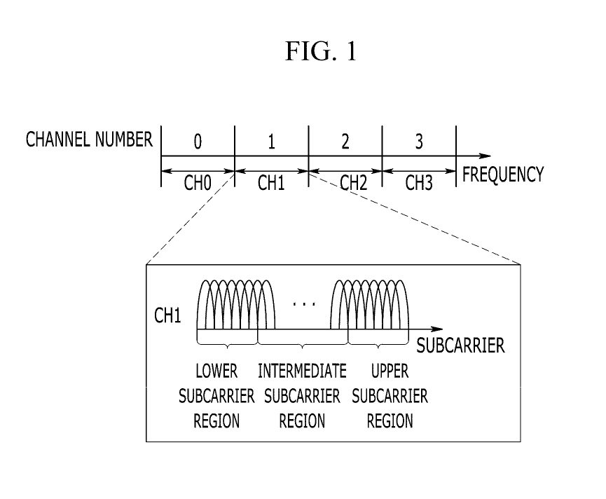

FIG. 1 is a view illustrating one example of a frequency channel used in a wireless communication system according to an exemplary embodiment of the present invention.

Referring to FIG. 1, in the wireless communication system, respective four frequency channels (CH0, CH1, CH2, CH3) of channel numbers 0, 1, 2 and 3, may be used. A single frequency channel includes a plurality of subcarriers. The plurality of subcarriers of a single frequency channel may be divided into a plurality of subcarrier regions, for example, a lower subcarrier region, an upper subcarrier region, and an intermediate subcarrier region between the lower subcarrier region and the upper subcarrier region.

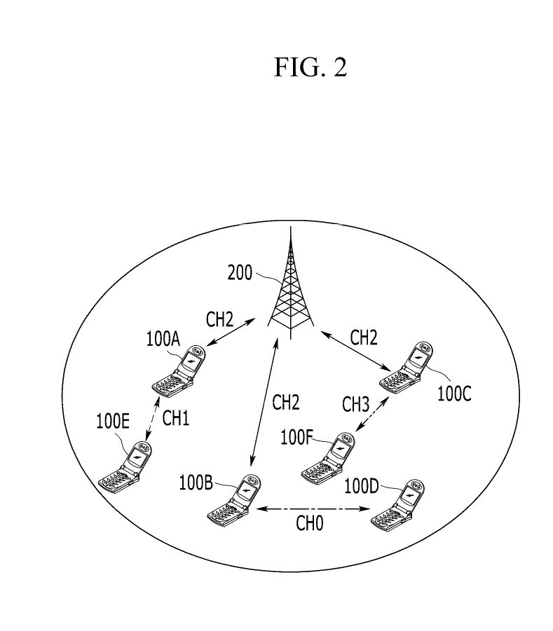

FIG. 2 is a view illustrating one example of a wireless communication system according to an exemplary embodiment of the present invention.

Referring to FIG. 2, a wireless communication system includes a plurality of terminals, for example, terminals 100a to 100f, and a base station 200.

The terminals 100a to 100f are the end points of a wireless channel, and perform wireless communication with the base station 200 and another terminal through frequency channels. A unicast, broadcast or multicast wireless communication scheme may be used between the terminal 100a to 100f and the base station 200 or between the terminal 100a to 100f.

The base station 200 performs wireless communication the terminals 100a to 100f, located within its wireless communication zone, through frequency channels.

For example, the terminals 100a, 100b, and 100c may perform direct wireless communication with the base station 200 through the frequency channel CH2 of the channel number 2. The terminals 100a and 100e may perform wireless communication with each other through the frequency channel CH1 of the channel number 1, the terminals 100c and 100f may perform wireless communication with each other through the frequency channel CH3 of the channel number 3, and the terminals 100b and 100d may perform wireless communication with each other through the frequency channel CH0 of the channel number 0.

Before transmitting data through frequency channels, transmission apparatuses of those terminals 100a to 100f and the base station 200 recognize the status of a frequency channel of interest through which data is to be transmitted. For example, the transmission apparatus may check the frequency channel of a reception signal, thus determining whether or not the channel of interest is available to transmit data. The transmission apparatus selects an available channel of interest and transmits data through the channel.

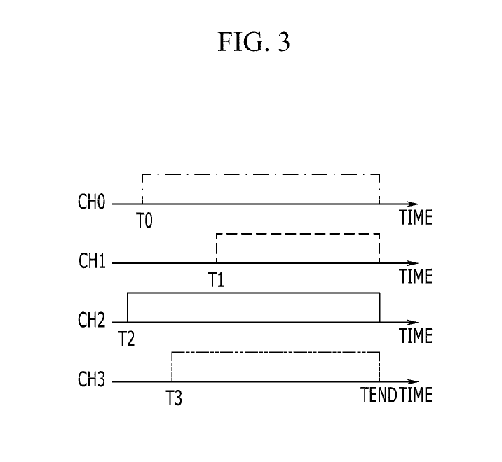

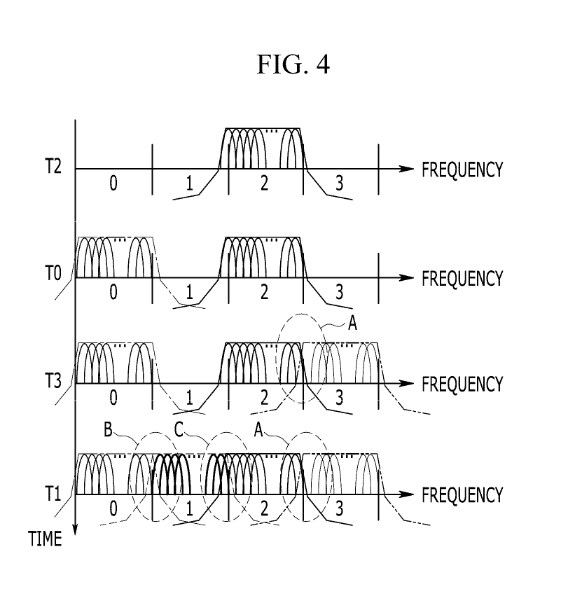

FIG. 3 is a view illustrating one example of the activation order and occupancy period of a frequency channel, being used in a wireless communication system according to an exemplary embodiment of the present invention, on a time axis. FIG. 4 is a view illustrating interference between adjacent channels, which may occur in a wireless communication system according to an exemplary embodiment of the present invention, on a frequency axis.

Referring to FIG. 3, the four frequency channels CH0, CH1, CH2 and CH3 used in the wireless communication system are activated in the order of channels numbers 2, 0 3 and 1. In this case, the start times of activating the frequency channels CH0, CH1, CH2 and CH3 are T0, T1, T2 and T3, and the end times of the frequency channels CH0, CH1, CH2 and CH3 may be Tend, which is the same therebetween.

In a case where such frequency channels CH0, CH1, CH2, and CH3 are used in the wireless communication system, interference between adjacent channels occurs as shown in FIG. 4. That is, at T0, the two frequency channels CH0 and the CH2 are spaced apart from each other, and thus interference does not occur between the two frequency channels CH0 and CH2. However, as the two frequency channels CH2 and CH3 adjacent to each other at the time T3 are all activated, interference between the two frequency channels CH2 and CH3 occurs in section A from the time T3 until the termination of the frequency channel. Furthermore, at the time 1, the two adjacent frequency channels CH0 and CH1 are all activated, causing interference in sections B and C from the time T1 until the termination of the frequency channel.

Hereinafter, a method for reducing interference between adjacent channels will be described.

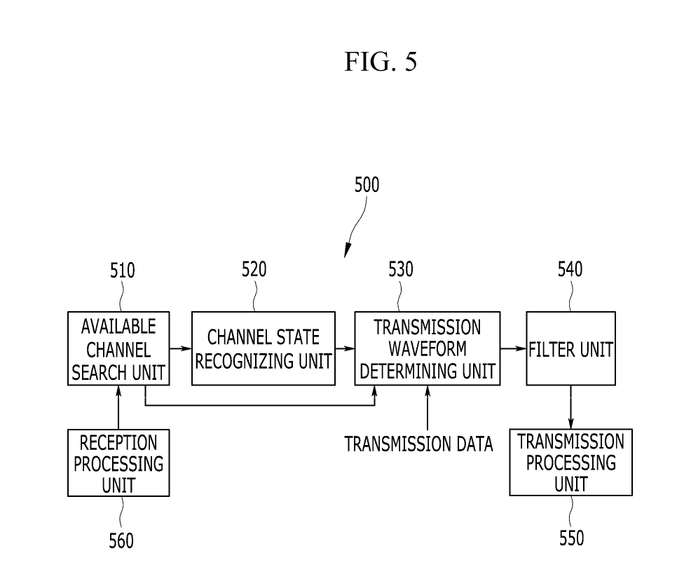

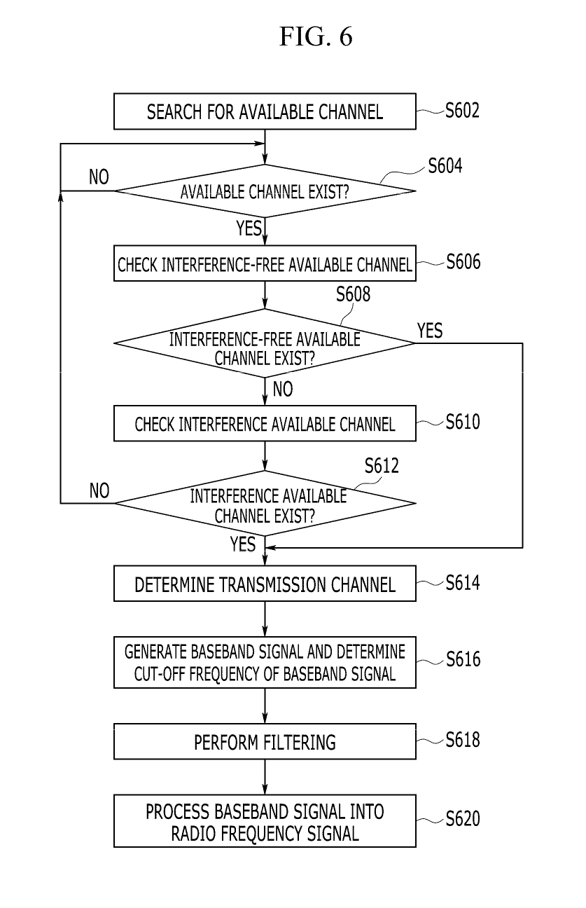

FIG. 5 is a view illustrating a transmission apparatus according to an exemplary embodiment of the present invention. FIG. 6 is a flowchart illustrating a transmission method for reducing interference between adjacent channels in a transmission apparatus according to an exemplary embodiment of the present invention.

Referring to FIG. 5, a transmission apparatus 500 includes an available channel search unit 510, a channel state unit 520, a transmission, waveform determining unit 530, a filter unit 540, recognition a transmission processing unit 550, and a reception processing unit 560.

Referring to FIG. 6, when transmission data is ready and thus the available channel search unit 510 receives a channel search command, an available channel which is not occupied is searched for (S602).

When an available channel does not exist (S602), the available channel search unit 510 is in a standby state until an available channel is searched for.

When an available channel exists (S604), the available channel search unit 510 checks whether or not there is an interference-free available channel from an occupancy state of an adjacent channel with respect to each searched available channel (S606). Here, the interference-free available channel means an available channel in which interference from an adjacent channel is less than a set value.

When there is an interference-free available channel (S608), the available channel search unit 510 determines the interference-free available channel as a transmission channel (S614), and information regarding the interference-free available channel is output to the transmission waveform determining unit 530.

When there is no interference-free available channel (S608), the available channel search unit 510 checks whether or not there is an interference available channel from the occupancy state of an adjacent channel with respect to each available channel (S610). Here, the interference available channel means an available channel in a case where interference from an adjacent channel is equal to or greater than a set value.

When there is an interference available channel (S612), the available channel search unit 510 outputs information regarding the interference available channel to the channel state recognition unit 520.

The channel state recognizing unit 520 determines one of interference available channels as an optimum transmission channel for the transmission of transmission data, and transmits it to the transmission waveform determining unit 530 (S614).

The transmission waveform determining unit 530 forms transmission data according to the occupancy state of an adjacent channel with respect to the transmission channel to thus generate a baseband signal, determines a cut-off frequency of the baseband signal according to the transmission channel, and outputs the same to the filter unit 540 (S616).

The filter unit 540 filters the baseband signal according to the cut-off frequency of the baseband signal and outputs the filtered signal to the transmission processing unit 550 (S618).

The transmission processing unit 550 processes the filtered baseband signal into a radio frequency signal, and transmits the radio frequency signal through a transmission (Tx) antenna (S620).

The reception processing unit 560 processes the radio frequency signal received through a reception (Rx) antenna into an Rx baseband signal and transmits the Rx baseband signal to the available channel search unit 510.

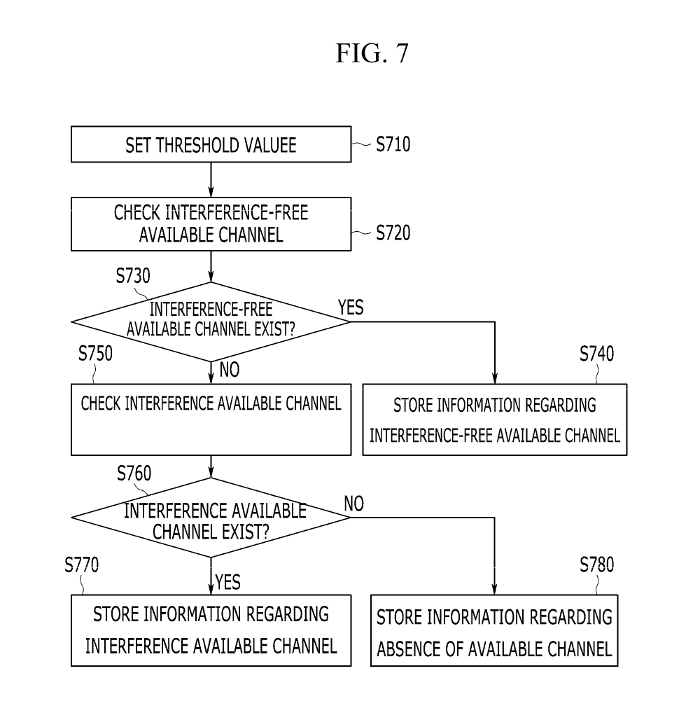

FIG. 7 is a flowchart illustrating an available-channel search method performed in an available-channel search unit.

Referring to FIG. 7, the available channel search unit 510, when receiving a channel search command, begins to search for an available channel.

The available channel search unit 510 sets a threshold value with respect to interference from an adjacent channel (S710).

The available channel search unit 510 checks whether an interference-free available channel in which interference from an adjacent channel does not exceed a threshold value is present among available frequency channels in the wireless communication system (S720). When there is an interference-free available channel exists (S730), the available channel search unit 510 stores information regarding the interference-free available channel (S740), and outputs the information regarding the interference-free available channel to the transmission waveform determining unit 530.

For example, in a case where the frequency channel number 2 has already been allocated among the respective frequency channels of channel numbers 0, 1 2 and 3, the frequency channel numbers 0, 1 and 3 are available channels, and the frequency channel number 0 spaced apart from the allocated frequency channel number 2 is least affected by interference with the frequency channel number 2. Accordingly, the available channel search unit 510 may search for the frequency channel number 0, which is least affected by interference with the allocated frequency channel number 2, as an interference-free available channel.

Meanwhile, when there is no interference-free available channel (S730), the available channel search unit 510 checks whether there is an interference available channel based on the occupancy state of an adjacent channel with respect to each available channel (S750).

When there is an interference available channel (S760), the available channel search unit 510 stores information regarding the interference available channel (S770), and outputs the information regarding the interference available channel to the channel state recognizing unit 520. For example, in a case where the frequency channel numbers 0 and 2 have already been allocated among the frequency channel numbers 0, 1, 2 and 3, the frequency channel numbers 1 and 3 are available channels, but they cause interference with the allocated frequency channels numbers 0 and 2 due to the adjacency to the frequency channel numbers 0 and 2. Thus, the available channel search unit 510 may search for the frequency channel number 1 and 3 as an interference available channel.

Also, when there is no interference available channel, the available channel search unit 510 determines that the entire frequency channels are occupied, and stores information regarding the absence of the available channel (S780).

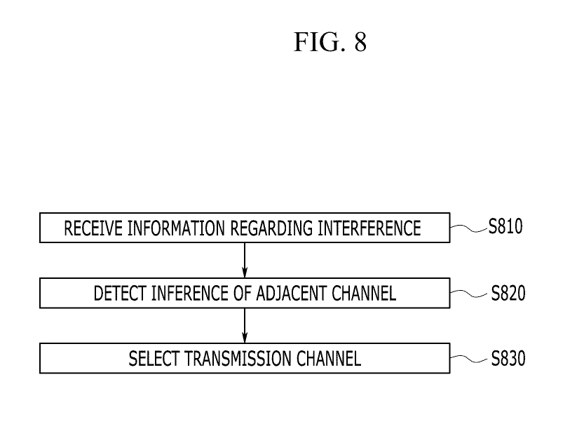

FIG. 8 is a flowchart illustrating a transmission-channel selection method performed in a channel state recognizing unit.

Referring to FIG. 8, when receiving information regarding an interference available channel from the available channel search unit 510 (S810), the channel state recognizing unit 520 detects interference of an adjacent channel (S820).

The channel state recognizing unit 520 selects at least one of interference available channels as a transmission channel on the basis of the detected interference of the adjacent channel (S830). Various methods may be applied to the transmission-channel selection method.

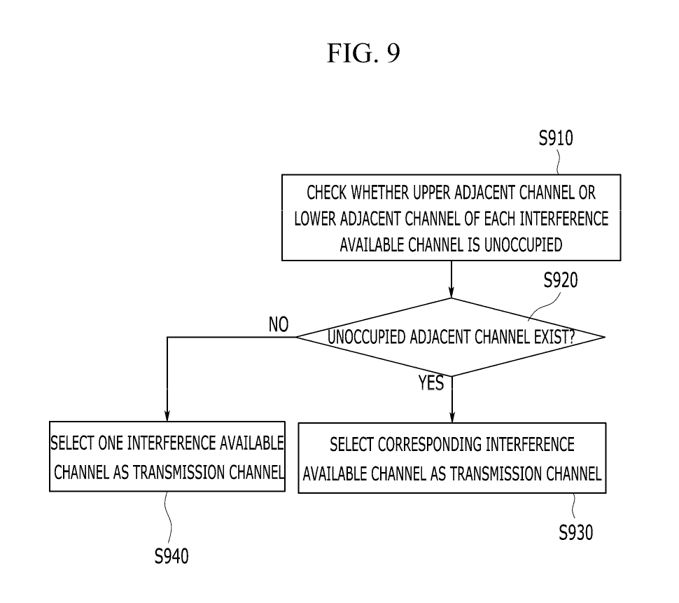

FIG. 9 is a flowchart illustrating one example of a method of selecting a transmission channel in a channel state recognizing unit according to an exemplary embodiment of the present invention.

Referring to FIG. 9, the channel state recognizing unit 520 checks whether or not one of upper and lower adjacent channels of each interference available channel is unoccupied (S910).

When there is an interference available channel one of upper and lower adjacent channels of which is unoccupied (S920), the channel state recognizing unit may selects this interference available channel as a transmission channel (S930).

Meanwhile, if both the upper and lower adjacent channels are occupied (S920), the channel state recognizing unit 520 may select one available channel the upper and lower adjacent channels of which are occupied, as a transmission channel (S940).

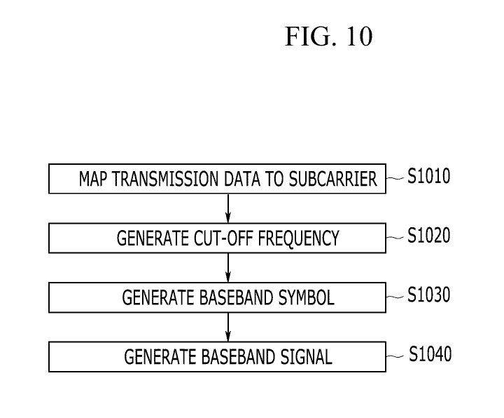

FIG. 10 is a flowchart illustrating a method of generating a baseband signal in a transmission waveform determining unit shown in FIG. 5.

Referring to FIG. 10, the transmission waveform determining unit 530 performs mapping so as to associates transmission data with a subcarrier according to a state of the transmission channel (S1010).

The transmission waveform determining unit 530 generates a cut-off frequency of a baseband signal in a channel bandwidth of the mapped subcarrier (S1020). The transmission waveform determining unit 530 generates a baseband symbol by using a result of the subcarrier mapping (S1030) and generates a baseband signal from the baseband symbol (S1040).

The transmission waveform determining unit 530 outputs the baseband signal and the cut-off frequency information of the baseband signal to the filter unit 540.

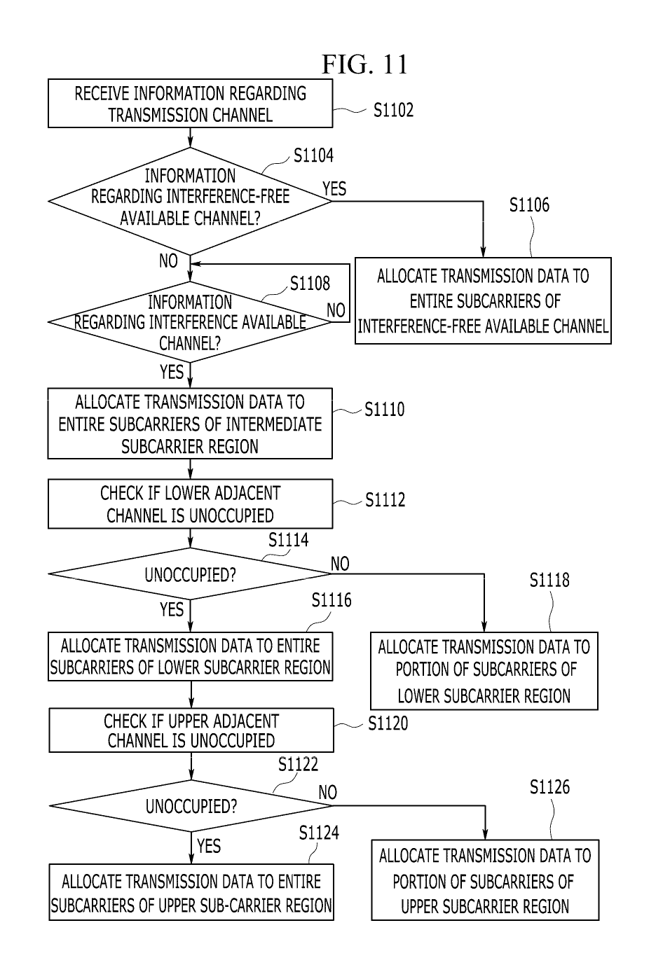

FIG. 11 is a flowchart illustrating a subcarrier mapping method of the transmission waveform determining unit according to an exemplary embodiment of the present invention.

Referring to FIG. 11, the transmission waveform determining unit 530 receives information regarding a transmission channel from the available channel search unit 510 or the channel state recognizing unit 520 (S1102).

When information regarding an interference-free available channel is received from the information regarding the transmission channel from the available channel search unit 510 (S1104), the waveform determining unit 530 allocates transmission data to the entire subcarriers of the interference-free available channel (S1106).

In contrast, when information regarding an interference available channel is received from the information regarding the transmission channel from the channel state recognizing unit 520 (S1108), the transmission waveform determining unit 530 allocates transmission data to a subcarrier in an intermediate subcarrier region of the transmission channel (S1110).

Thereafter, the transmission waveform determining unit 530 checks whether the lower adjacent channel of the interference available channel is unoccupied (S1112). When the lower adjacent channel of the interference available channel is unoccupied (S1114), the transmission waveform determining unit 530 additionally allocates transmission data to the entire subcarriers of the lower subcarrier region of the interference available channel (S1116). When the lower adjacent channel of the interference available channel is occupied, transmission data may be allocated to a portion of subcarriers in the lower subcarrier region according to the state of the lower adjacent channel (S1118).

Thereafter, the transmission waveform determining unit 530 checks whether the upper adjacent channel of the interference available channel is unoccupied (S1120). When the upper adjacent channel of the interference available channel is unoccupied (S1122), the transmission waveform determining unit 530 additionally allocates transmission data to the entire subcarriers of the upper subcarrier region of the interference available channel (S1124). When the upper adjacent channel of the interference available channel is occupied (S1122), the transmission waveform determining unit 530 may allocate transmission data to a portion of subcarriers of the upper subcarrier region according to the state of the upper adjacent channel (S1126).

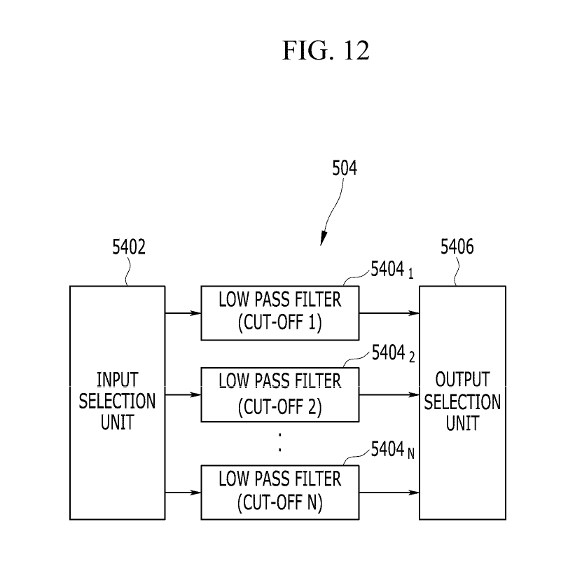

FIG. 12 is a block diagram illustrating one example of the filter unit according to an exemplary embodiment of the present invention.

Referring to FIG. 12, the filter unit 540 includes an input selection part 5402, a plurality of low pass filters 5404₁ to 5404_{N}, and an output selection part 5406.

The input selection part 5402 receives a baseband signal and the cut-off frequency information of the baseband signal from the transmission waveform determining unit 530, and outputs the baseband signal to one of the plurality of low pass filter 5404₁ to 5404_{N} according to the cut-off frequency information of the baseband signal.

The plurality of low pass filters 5404₁ to 5404_{N} filter the baseband signal at respectively predetermined cut-off frequencies cut-off 1 to cut-off N, and output the filter signal to the output selection part 5406.

The output selection part 5406 receives the cut-off frequency information of the baseband signal from the transmission waveform determining unit 530, and outputs the baseband signal filtered by a low pass filter corresponding to the cut-off frequency information of the baseband signal.

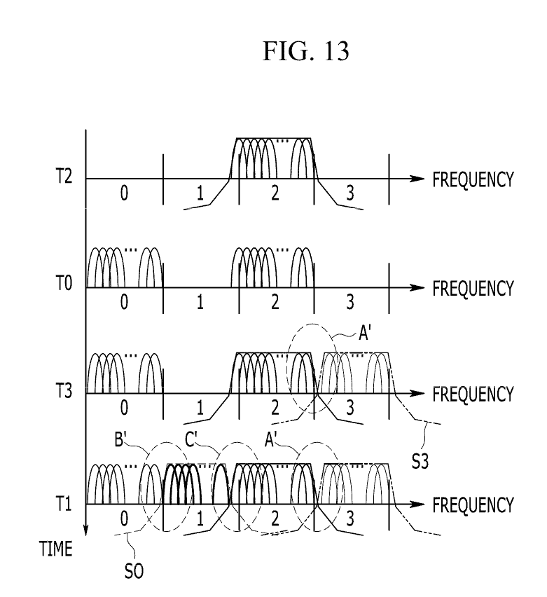

Hereinafter, the effect of alleviating interference between adjacent channels according to an exemplary embodiment of the present invention will be described with reference to FIG. 13.

FIG. 13 is a view illustrating interference between adjacent channels on a frequency axis according to the transmission method according to an exemplary embodiment of the present invention.

Referring to FIG. 13, in a case where the frequency channel number 2 among the frequency channel numbers 0, 1, 2 and 3 has already been allocated at T2, the available channel search unit 510 of the transmission apparatus 500 selects the frequency channel number 0, which has the least interference with the frequency channel number 2 at T0, from among available channels of the frequency channel numbers 0, 1 and 3 as a transmission channel, and transmits it to the transmission waveform determining unit 530.

Then, the transmission waveform determining unit 530 checks that both the upper and lower adjacent channels of the frequency channel number 0 are unoccupied, and allocates transmission data to the entire subcarriers of the frequency channel number 0.

Subsequently, the available channel search unit 510 recognizes at T3 that the frequency channel numbers 1 and 3 CH1 and CH3 are interference available channels where interference is caused by the adjacent frequency channels CH0 and CH2, and transmits information regarding the frequency channels CH1 and CH3 to the channel state recognizing unit 520.

The channel state recognizing unit 520 checks whether or not in the frequency channels CH1 and CH3, there is an interference available channel one of the upper and lower adjacent channels of which is unoccupied. In this case, since the frequency channel CH1 is in the state where both the upper adjacent channel CH2 and the lower adjacent channel CH1 are occupied, and the frequency channel CH3 is in the state where only the lower adjacent channel CH2 is occupied, the channel state recognizing unit 520 may select, at T3, the frequency channel CH3 from between the frequency channels CH1 and CH3 as a transmission channel.

Then, the transmission waveform determining unit 530 generates a baseband signal by forming transmission data so as to alleviate interference with the lower adjacent channel CH2 of the frequency channel CH3. Furthermore, the transmission waveform determining unit 530 determines the cut-off frequency of the baseband signal so as to alleviate interference with the lower adjacent channel CH2 of the frequency channel CH3. The filter unit 540 filters the baseband signal at the cut-off frequency and outputs the filtered baseband signal. As a result, the baseband signal is expressed by S3, and as shown in region A′, interference between the frequency channels CH2 and CH3 is suppressed as compared to FIG. 4.

Thereafter, the available channel search unit 510 recognizes at T1 that the last frequency channel number 1 is an interference available channel where interference is caused by the adjacent channels CH0 and CH2, and transmits information regarding the frequency channel CH1 to the channel state recognizing unit 520.

The channel state recognizing unit checks that both the upper and lower adjacent channels CH2 and CH0 of the frequency channel CH1 are occupied, and selects the frequency channel CH1 as a transmission channel.

Then, the transmission waveform determining unit 530 generates a baseband signal by forming transmission data so as to alleviate interference with the upper and lower adjacent channels of the frequency channel CH1. Also, the transmission waveform determining unit 530 determines the cut-off frequency of the baseband signal so as to alleviate interference with the upper and lower adjacent channels CH2 and CH0 of the frequency channel CH1. Then, the filter unit 540 filters the baseband signal at the cut-off frequency and outputs the filtered baseband. As a result, the baseband signal is expressed as S1, and as shown in regions B′ and C′, interference between the frequency channels CH1 and CH2 and the frequency channels CH1 and CH0 are suppressed as compared to FIG. 4.

According to an exemplary embodiment of the present invention, interference with respect to a channel in use is suppressed by recognizing a state of a channel which has already been in use before signal transmission, while interference affected by the channel itself or another channel is minimized, thus actively coping with deterioration in communication performed, caused by interference between adjacent channels.

The exemplary embodiments of the present invention may also be implemented by a program realizing functions corresponding to the construction of the embodiment, and a recording medium on which the program is recorded, other than the apparatus and/or method described above. Such implementation may be easily made from the disclosure of the above embodiments by those skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A transmission apparatus comprising:
an available channel search unit determining, as a transmission channel, an available channel upper and lower adjacent channels of which are all unoccupied among one or more available channels which are not occupied by adjacent channels;
a channel state recognizing unit determining as a transmission channel one of the one or more available channels from occupancy states of the upper adjacent channel and the lower adjacent channel when both the upper adjacent channel and the lower adjacent channel are not unoccupied;
a transmission waveform determining unit allocating transmission data to at least a portion of subcarriers among entire subcarriers of the transmission channel according to the occupancy states of an upper adjacent channel and a lower adjacent channel of the transmission channel and generating a baseband signal using the subcarriers allocated the transmission data;
a transmission processing unit processing the baseband signal into a radio frequency signal and transmitting the radio frequency signal.

2. The transmission apparatus of claim 1, further comprising a filter unit filtering the baseband signal according to a cut-off frequency of the baseband signal and outputting the filtered baseband signal to the transmission processing unit.

3. The transmission apparatus of claim 2, wherein the transmission waveform determining unit determines the cut-off frequency of the baseband signal according to the occupancy states of the upper adjacent channel and the lower adjacent channel of the transmission channel.

4. The transmission apparatus of claim 3, wherein the filter unit comprises:
a plurality of low pass filters each filtering a signal input at each cut-off frequency and outputting the filtered signal; and
an input selection unit outputting the baseband signal to one of the plurality of low pass filters according to the cut-off frequency determined from the transmission waveform determining unit.

5. The transmission apparatus of claim 1, wherein the transmission waveform determining unit allocates the transmission data to the entire subcarriers of the transmission channel when both the upper adjacent channel and the lower adjacent channel of the transmission channel are unoccupied.

6. The transmission apparatus of claim 1, wherein the transmission channel comprises a plurality of subcarriers in an upper subcarrier region, a plurality of subcarriers in a lower subcarrier region, and a plurality of subcarriers in an intermediate subcarrier region between the upper subcarrier region and the lower subcarrier region, and
the transmission waveform determining unit allocating transmission data to the plurality of subcarriers of the intermediate subcarrier region of the transmission channel when only one of the upper and lower adjacent channels is unoccupied, and allocating the transmission data to the plurality of subcarrier in the upper subcarrier region or lower subcarrier region corresponding to the unoccupied channel.

7. The transmission apparatus of claim 5, wherein the transmission waveform determining unit allocates transmission data to the plurality of subcarriers of the intermediate subcarrier region of the transmission channel when both the upper adjacent channel and the lower adjacent channel of the transmission channel are occupied, and allocates the transmission data to a portion of the subcarriers of the upper subcarrier region and a portion of the subcarriers of the lower subcarrier region.

8. The transmission apparatus of claim 1, wherein the channel state recognizing unit selects as a transmission channel an available channel one of the upper and lower adjacent channels of which is occupied.

9. A transmission method for a transmission apparatus, the transmission method comprising:
selecting a transmission channel from among unoccupied available channels;
mapping data to at least a portion of subcarrier of the transmission channel according to occupancy states of an upper adjacent channel and a lower adjacent channel adjacent to the transmission channel;
generating a baseband signal from the subcarrier to which the data is mapped; and
processing the baseband signal and transmitting the signal.

10. The transmission method of claim 9, wherein the generating comprises:
determining a cut-off frequency of the baseband signal according to the occupancy states of the upper adjacent channel and the lower adjacent channel adjacent to the transmission channel; and
filtering the baseband signal at the cut-off frequency.

11. The transmission method of claim 10, wherein the determining comprises determining the cut-off frequency according to a channel bandwidth of a subcarrier to which the data is mapped.

12. The transmission method of claim 9, wherein the generating comprises allocating the data to entire subcarriers of the transmission channel when both the upper adjacent channel and the lower adjacent channel of the transmission channel are unoccupied.

13. The transmission method of claim 9, wherein a plurality of subcarriers of the transmission channel are divided into a plurality of subcarriers of an upper subcarrier region, a plurality of subcarriers of a lower subcarrier region, and a plurality of subcarriers in an intermediate subcarrier region between the upper subcarrier region and the lower subcarrier region, and
wherein the generating comprises:
allocating the data to the plurality of subcarriers of the intermediate subcarrier region of the transmission channel when only one of the upper adjacent channel and the lower adjacent channel is unoccupied; and
allocating the data to the plurality of subcarriers of the upper subcarrier region or lower subcarrier region adjacent to the unoccupied channel.

14. The transmission method of claim 13, wherein a plurality of subcarriers of the transmission channel are divided into a plurality of subcarriers of an upper subcarrier region, a plurality of subcarriers of a lower subcarrier region, and a plurality of subcarriers of an intermediate subcarrier region between the upper subcarrier region and the lower subcarrier region,
wherein the generating comprises:
allocating the data to the plurality of subcarriers of the intermediate subcarrier region of the transmission channel when both the upper adjacent channel and the lower adjacent channel of the transmission channel are occupied; and
allocating the data to a portion of the subcarriers of the upper subcarrier region of the transmission channel and a portion of the subcarriers of the lower subcarrier region thereof.

15. A transmission method for a transmission apparatus, comprising:
selecting a transmission channel through which a transmission signal is to be transmitted from among unoccupied available channels; and
forming the transmission signal according to occupancy states of an upper adjacent channel and a lower adjacent channel adjacent to the transmission channel.

16. The transmission method of claim 15, wherein the forming comprises:
selecting a subcarrier to which transmission data is to be mapped from among a plurality of subcarriers of the transmission channel according to the occupancy states of the upper adjacent channel and the lower adjacent channel; and
mapping the transmission data to the selected subcarrier and converting the data into a baseband signal.

17. The transmission method of claim 16, wherein the forming further comprises:
determining a cut-off frequency according to a channel bandwidth of the selected subcarrier; and
filtering the baseband signal at the cut-off frequency.

18. The transmission method of claim 16, wherein a plurality of subcarriers of the transmission channel are divided into a plurality of subcarriers of an upper subcarrier region, a plurality of subcarriers of a lower subcarrier region, and a plurality of subcarriers of an intermediate subcarrier region between the upper subcarrier region and the lower subcarrier region,
wherein the selecting comprises selecting the plurality of subcarriers of the intermediate subcarrier region, a portion of the subcarriers of the upper subcarrier region, and a portion of the subcarriers of the lower subcarrier region as subcarriers to which the transmission data is to be mapped, when both the upper adjacent region and the lower adjacent region are occupied.

19. The transmission method of claim 18, wherein the selecting further comprises:
when one of the upper adjacent channel and the lower adjacent channel is occupied, selecting the plurality of subcarriers of the intermediate subcarrier region, and the plurality of subcarriers of the upper subcarrier region or the lower subcarrier region adjacent to the unoccupied adjacent channel as subcarriers to which the transmission data are to be mapped.

20. The transmission method of claim 16, wherein the selecting comprises selecting entire subcarriers of the transmission channel as subcarriers to which the transmission data is to be mapped, when both the upper adjacent channel and the lower adjacent channel are unoccupied.
